(19) United States
(12) Patent Application Publication
(10) Pub. No.: US 2007/0261224 A1
(43) Pub. Date: Nov. 15, 2007

(54) METHODS AND ARTICLES IN HAVING A FRINGED MICROPROTRUSION SURFACE STRUCTURE

(75) Inventor: David G. McLeod, Rochester, MI (US)

Correspondence Address: DOBRUSIN & THENNISCH PC, 29 W. LAWRENCE STREET, STE. 210, PONTIAC, MI, 48342, US

(73) Assignee: Dow Global Technologies Inc.

(21) Appl. No.: 11/746,977

(22) Filed: May 10, 2007

Related U.S. Application Data
(60) Provisional application No. 60/747,019, filed on May 11, 2006.

(51) Int. Cl. B23P 11/00

(52) U.S. Cl. 29/428

(57) ABSTRACT

Composite articles and a method for making the same, wherein the articles include at least two bodies that are attached at an interface that includes a fringed microprotrusion surface structure. The method generally includes the steps of providing a first body that includes a fringed microprotrusion surface structure on one or more surfaces; and attaching to the first body, a second body for defining the interface that includes at least a portion of the fringed microprotrusion surface structure.

### CLAIM OF BENEFIT OF FILING DATE

The present application claims the benefit of the filing date of U.S. Application Ser. No. 60/747,019, filed May 11, 2006, hereby incorporated by reference.

### FIELD OF THE INVENTION

The present invention relates to composite articles and methods of making the same, and particularly articles and methods that include an interface between bodies that include a fringed microprotrusion surface structure.

### BACKGROUND OF THE INVENTION

There is a need in the art for composite articles, particularly articles made of at least two bodies of dissimilar material that exhibit high integrity bonds between the bodies. It would be attractive to achieve such composites without the need for an intermediate bonding agent such as an adhesive or a primer. It would also be attractive to manufacture such articles with relatively few processing steps.

Examples of fringed surface structures are described in U.S. Pat. Nos. 6,946,182 and 6,872,438, both incorporated by reference.

### SUMMARY OF THE INVENTION

The present invention is directed to composite articles and a method for making the same, wherein the articles include at least two bodies that are attached at an interface that includes a fringed microprotrusion surface structure. The method generally includes the steps of providing a first body that includes a fringed microprotrusion surface structure on one or more surfaces; and attaching to the first body, a second body for defining the interface that includes at least a portion of the fringed microprotrusion surface structure.

In another aspect, the invention is directed to a method that includes the steps of providing an engraved tool having defined therein a plurality of micro-recesses within a wall defining a cavity of the tool; filling the tool cavity, including the micro-recesses, with a molten material; solidifying the molten material; and removing the resulting body from the tool cavity, wherein upon removal, the resulting body includes a fringed surface structure, the fringed surface being characterized as including an array of a plurality of microprotrusions.

The teachings herein thus also pertain to methods for making the first body (as discussed above) and articles produced therefrom, independent of and without the need for attaching any second body.

### DESCRIPTION OF THE DRAWINGS

FIG. 1A is a perspective view of an illustrative fringed microprotrusion surface structure on a surface of a body.

FIG. 1B is a side sectional view of an article according to the present teachings.

FIG. 2 is a plan view of an illustrative microprotrusion.

FIG. 3A-3E are perspective views of alternative microprotrusion structures.

FIG. 4 is a side sectional view of an illustrative fringed microprotrusion surface structure on a surface of a body, the microprotrusions effectively defining an array of microdepressions.

### DETAILED DESCRIPTION OF THE INVENTION

Referring first to FIGS. 1A and 1B, a method for making a composite article 10, comprising the steps of providing a first body 12 that includes a fringed microprotrusion surface structure 14; and attaching to the first body 12, a second body 16 for defining an interface 18 region that includes at least a portion of the fringed microprotrusion surface structure 14.

The fringed microprotrusion surface structure 14 may have any configuration suitable for achieving a strong joint between the first and the second body. Referring to FIG. 1, for example, in one particular aspect, the fringed surface structure is characterized by a plurality of microprotrusions 20 that project from a surface 22 of the first body. The microprotrusions 20 may have any suitable shape. For example, they may be generally columnar or another generally prismatic shape, conical, or any combination thereof. The shape optionally may incorporate fractal geometry.

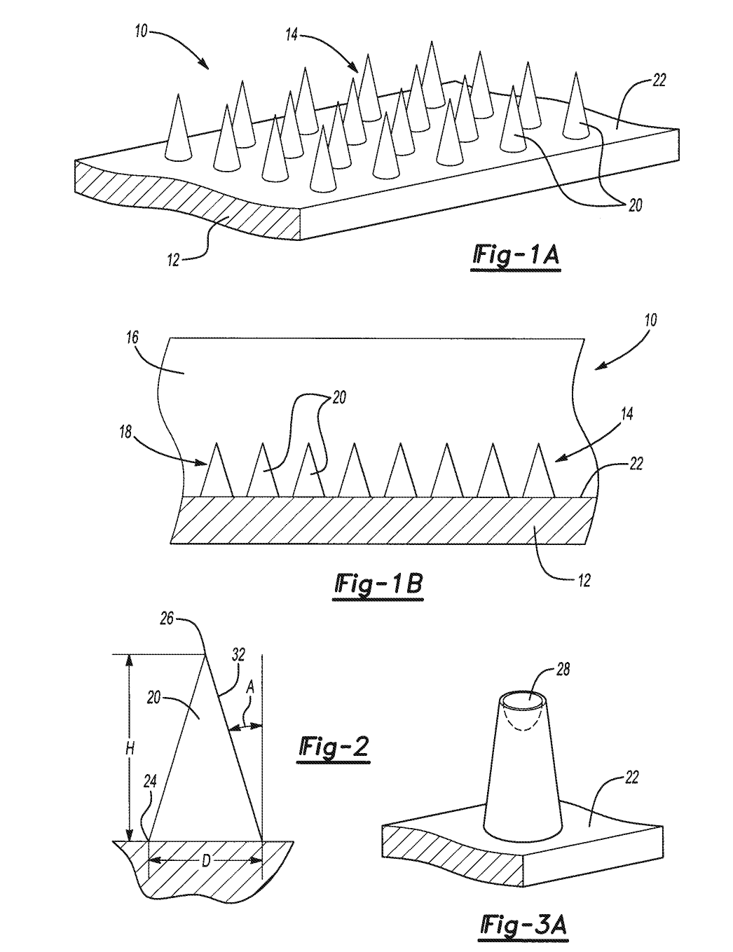

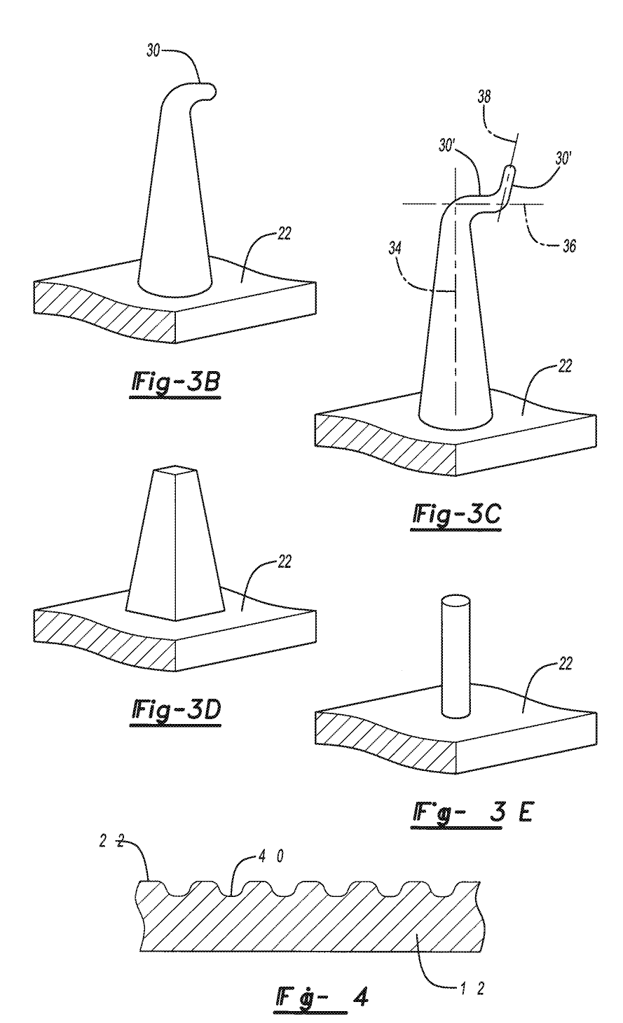

One specific approach that exhibits excellent characteristics is to employ a plurality of generally conical microprotrusions, such as the illustrative microprotrusion 18 shown in FIG. 2. The microprotrusion of FIG. 2 has a base at a proximal end 24, and a tip 26 at a distal end. The base, tip, or both may include a hollow portion or a solid portion. For example, it may be possible that the tip 26 has a crater 28 defined therein, such as is shown in FIG. 3A. The tip may be configured substantially straight, so that it projects generally away (e.g., orthogonally or otherwise) from the surface 22, as in FIG. 2. It may include a hooked portion 30, such as shown in FIG. 3B. It may include a plurality of hooked portions 30′, as seen in FIG. 3C. Any combination of hooked or straight tip portions, solid or hollow portions, orthogonal disposition or otherwise may be employed. Typically microprotrusion structures that include a hook structure will employ a secondary forming operation for making the hook. Such operation may include a step of contacting the microprotrusions with a tool, applying energy (e.g., heat), or both for deforming them.

Referring again to FIG. 2, the microprotrusion will typically have a height dimension (H), and a base dimensions, such as width or diameter (D), such that a ratio (R) is obtainable, wherein R=H/D, as well as an external surface area. In a number of applications, desirably, the microprotrusion will have a base area (BA) that is small than the crossectional area at any point along the height of the microprotrusion. Thus, it is contemplated that the microprotrusions in such instances will include at least one tapered wall surface 32, which tapers at a draft angle (A) (which corresponds substantially identically with the draft angle in recesses within the tool for forming the microprotusions), which generally will range from about 0.5 to about 75°. By way of example, without limitation, Table 1 identifies illustrative values of A for various values of R (height and diameter units specified are arbitrary):

TABLE 1

| Height | Diameter | Draft Angle |
|---|---|---|
| 1 | 0.5 | 45° |
| 1 | 1 | 26.5° |
| 2 | 1 | 14° |
| 3 | 1 | 9.5° |
| 4 | 1 | 7° |
| 5 | 1 | 5.7° |
| 6 | 1 | 4.8° |
| 7 | 1 | 4.0° |

The concentration of microprotrusions per unit area of a surface (wherein the unit area of surface is calculated exclusive of any area contributed by the surface of the microprotrusions) can vary as desired, and will depend upon such considerations as the protrusion diameter, the nature of the material to be molded, or the like. By way of further illustration, Table 2 illustrates examples of approximate microprotrusion densities believed possible (e.g., using either a 200 or 300 micron depth and a steel tool), and varying the microprotrusion width or diameter as shown. Variations in values in the amount of about +/−25% of the recited values are contemplated as well. It is seen that on the order of about 20 to 70% of the overall unit area of a surface may be populated with microprotrusions.

TABLE 2

| H = 200 micron | H = 300 micron | Aerial density/cm² |
|---|---|---|
| 165μ | 135μ | 3500 |
| 195μ | 160μ | 2500 |
| 280μ | 230μ | 1200 |
| 345μ | 280μ | 800 |

Further, microprotrusions herein typically will be present in an array (see FIG. 1) that includes a plurality of microprotrusions concentrated within a region of the surface 22. Such an array may be randomly arranged, arranged according to a predefined pattern, uniformly distributed or any combination thereof. The surface 22 may be substantially entirely covered by a single array or a plurality of arrays. Within each array, the dimensions, the geometry or both of the microprotrusions may be substantially the same as or different relative to each other. Further each array within a surface 22 may substantially the same as or different relative to each other array.

By way of example, without limitation, it is envisioned that the microprotrusions within an array may each have about the same height, or they may vary in height by as much as about 20% or higher (e.g., for a variation of about 30% in height, an array may have a plurality of microprotrusions that are about 200 microns to about 300 microns). Desirably, in one particular aspect, the microprotrusions and will have an average height as tall as about 100 microns, or even as high as about 200 or even 300 microns or taller. For example, the microprotrusions herein will have an average height ranging from about 25 to about 950 microns (e.g., below 1000 microns (1 mm)), and still more particularly about 40 to about 500 microns. In a still more specific aspect, it is contemplated that at least about 50% (and still more specifically, at least about 75%) of the microprotrusions will have an average height as tall as about 160 microns, or even as high as about 200 microns or taller.

By way of further example, without limitation, it is envisioned that the microprotrusions within an array herein will have an average width or diameter dimension as large as about 20 microns or larger, and more typically at least about 50 microns. More particularly, the microprotrusions herein will have an average width or diameter dimension ranging from about 50 to about 400 microns, and still more particularly about 95 to about 120 microns. In a still more specific aspect, it is contemplated that at least about 50% (and still more specifically, at least about 75% of the microprotrusions) will have an average width or diameter dimension of at least about 50 microns, or even as large as about 150 microns.

It should be recognized that some geometries, such as for a microprotrusion with a triangular, rectangular, or other geometry base, the width refers to the largest dimension of the base. The draft angle A will typically range from about 0.5 to about 85°, and more specifically about 5 to about 20°.

In one specific example herein, the microprotrusions will be generally conical. They may have sharp distal ends, blunted distal ends (e.g., beaded), some irregular geometry (e.g., a jagged tip) or a combination thereof. In one specific approach, the generally conical microprotrusions are generally closed at their distal ends, with the distal ends being substantially free of a hollow portion.

FIGS. 3A-3E illustrate examples of alternative structures for microprotrusions. FIG. 3A shows a microprotrusion having a hollow tip for defining a crater 28. FIG. 3B illustrates a microprotrusion having the hook 30 on a distal end portion. One specific approach contemplates that the distal end of the hook projects laterally. FIG. 3C illustrates a microprotrusion having a modified hook 30′ on its distal end portion, wherein the axis 34 of the main body and the axis 36 of an intermediate portion are generally at an angle relative to each other and optionally relative to an axis 38 of a tip. FIG. 3D shows a microprotrusion with a pyramid geometry shown optionally without a pointed tip. FIG. 3E shows a microprotrusion with a generally cylindrical geometry. Features shown in the above, of course, can be modified or adapted for any of the other embodiments shown herein. For example, a hook could be included on the embodiments of FIG. 3D or 3E. Multiple axes end geometries as in FIG. 3C can be employed on any of the other microprotrusions described. Hollow tips (e.g., as may result from a calendaring operation) may also be employed as shown in FIG. 3A.

FIG. 4 shows another approach to the present invention. In this embodiment the surface 22 that is defined in the body 12 has a topography characterized by a plurality of microdepressions 40 (which may have similar dimensions for depth and width/diameter and the corresponding height and width/diameter as discussed herein). Effectively, the microprotrusions are formed so their distal ends include the surface 22. Thus, shown in FIG. 4 are microprotrusions having a generally flat upper surface. However, it is possible that the upper surface may have the topography such as shown in one of the previous examples, or as elsewhere described herein. One approach to achieving such a structure is to select processing conditions so that when contacting the tool for forming the microprotrusions, a combination of heat will cause gasses that are trapped against the tool wall to effectively repel filling of the cavity in the tool and thus form microdepressions within the surface 22. Such an application may find additional utility, for example, in the coating art for improving the surface area available for coating, the surface tension of the region available for coating, or both. It should be appreciated the possibility that by controlling the combination of trapped gas and heat it is possible to cause a beaded structure to arise in lieu of, or in addition to a full extension microprotrusion or microdepression.

The microprotrusion surface structure on a surface of the first body may be over substantially all or only portions of the surface. For example, measured as if no microprotrusion surface structure existed, it is possible that the microprotrusion surface structure will be present in an amount of at least about 10% by area of the first body, at least about 25% by area of the first body, at least about 50% by area of the first body, or even as much as at least about 80% by area of the first body. Within the area occupied by the microprotrusions, it is contemplated that the microprotrusions are present in a concentration of at least about 100 protrusions per cm², more particularly at least about 100 protrusions per cm², and still more particularly at least about 400 protrusions per cm², or even still more particularly, at least about 800 protrusions per cm². In particular examples, the concentrations are at least about 1200 protrusions per cm², or even as high as at least about 2500 per cm² or higher (e.g. up to about 3500 per cm²).

The first body, the second body or both may be selected from a metal, a plastic, a ceramic, or any combination thereof. The first body, the second body or both may be a composite (e.g., a laminate or other layered body, a distribution of one or more phases within a matrix phase, or a combination thereof). It should be appreciated that the use of the terms “first” and “second” are for convenience and are not intended as limiting or excluding the presence of additional bodies. One particular example, without limitation, employs a plastic first body and a plastic second body. Even more particularly, the plastic of the first body is a different plastic than the plastic of the second body. For example, a plastic from one family of plastics (e.g., a polyolefin (including but not limited to polyethylene, polypropylene, or a thermoplastic polyolefin), a polyamide, a polycarbonate, a thermoplastic polyurethane, a poly(meth)acrylate, a polysulphone, a polystyrene, a fluoropolymer, a polyphenylene oxide, a (meth)acrylonitrile, a thermoplastic elastomer (e.g., styrene-butadiene rubber), a polyvinyl (e.g., polyvinyl chloride), a polyester or other family) may be used for one of the plastic bodies. A plastic from another family of plastics may be used for another plastic body. For example, one approach may be to employ a first plastic body that comprises a thermoplastic material (e.g., a polyolefin) as its largest polymeric component, and a second plastic body that comprises a thermoset material (e.g., a thermoset polyurethane) as its largest polymeric component.

One particular example herein involves providing a first body that includes a thermoplastic, such as one selected from a polyolefin, a polyamide, a polycarbonate, a thermoplastic polyurethane, a poly(meth)acrylate, a polysulphone, a polystyrene, a fluoropolymer, a polyphenylene oxide, a (meth)acrylonitrile, a thermoplastic elastomer (e.g., styrene-butadiene rubber), a polyvinyl, a polyester, or any combination thereof (e.g., acylonitrile butadiene styrene (ABS), styrene acrylonitrile, polycarbonate/ABS, ABS/thermoplastic polyurethane, thermoplastic polyurethane elastomer). More specifically, the thermoplastic polymer of the first plastic body includes at least about 40 wt % of a polymer; still more specifically, at least about 55 wt % of a polymer; and still more specifically at least about 70 wt % of a polymer.

Examples of various of the above materials are available commercially from The Dow Chemical Company under the designations Calibre™ polycarbonate resins, Emerge™ ABS resins, Isoplast™ engineering thermoplastic polyurethane resins, Magnum™ ABS resins, Pellethane™ thermoplastic polyurethane elastomers, Prevail™ ABS/thermoplastic polyurethane resins, Pulse™ polycarbonate/ABS resins, or Tyril™ styrene acrylonitrile resins.

Any of the plastics herein may include art-disclosed additives or ingredients, such as one or more of a flexibility modifying agent, a light stabilizer, a flame retardant, a plasticizer, a filler (e.g., talc, mica, a nanoparticle filler, a conductive filler, calcium carbonate), a reinforcement (e.g., glass microspheres, beads, carbon fibers, mineral, glass or other ceramic fibers, oriented polymeric fibers, whiskers, rovings, scrim, tapes, etc.), anti-oxidant, slip-additive, nucleating agent, foaming agent, blowing agent, colorant, natural fibers or particles (e.g., hemp, jute, sisal, wood flour, banana leaves, flax, rice hulls, cellulose, or the like), or any combination thereof. One particular approach that is employed with various plastic that include a thermoplastic material as its largest polymeric component is to include a glass fiber reinforcement, e.g., in an amount of about 5 to about 65 weight percent (more specifically about 10 to about 40 weight percent) of the plastic material. Specifically, especially where the polymeric component will be a polyolefin, such as a polypropylene, an amount of a long glass fiber (e.g., a plurality of fibers having one or more initial lengths ranging from about 0.2 to about 25 mm). More specifically, in the resulting material at least 50% by weight of the total fibers range from about 0.4 to about 2.5 mm, and even more specifically, at least about 60 wt % of the total fibers have a length ranging 0.5 mm to about 1.5 mm.

The step of providing the first body may be fulfilled in any of a number of ways. A pre-fabricated body may be provided. The first body may be fabricated as part of the providing step. The first body may be fabricated at a location that is remote from the location at which the first body is attached to the second body (e.g., it is made and then transported, such as by rail, truck, air, boat, or otherwise), or generally at the same location (e.g., within the same manufacturing facility) where it is attached to the second body.

The first body may be manufactured according to any of a number of techniques. In general, the manufacturing technique will employ a suitable tool (e.g., a mold, a mold core, a die, a calendar roller, or the like) against which a charge of material is contacted for shaping the body, for imparting a microprotrusion surface structure or both. Thus, it is possible that the general shape of the body and the microprotrusion surfacing will occur in a common operation. Of course it is possible also that the first body will be formed to its desired shape and thereafter the microprotrusion surface structure added.

Among the various specific approaches to the manufacture of the first body, by way of example, the first body may be injection molded (with or without gas assist), compression molded, extruded, blow molded, vacuum molded, extrusion molded, injection compression molding, extrusion compression molding, rotational molded, thermoformed, cast, pultruded, stamped, forged, or any combination thereof. For first bodies that are plastic, it is particularly attractive to injection mold the body.

The techniques may be single operation techniques or they may employ one or more secondary processing operations. Further it is possible to incorporate one or more operations within a single operation, such as through the use of insert molding techniques.

In general, the methods herein contemplate the use of a single charge of material for forming the first body. However, it is possible that multiple bodies may be employed. For example, a bulk charge may be formed to a predetermined shape, and then a layer including a microprotrusion surface structure is added to the bulk charge (e.g., as a film, a sheet, a coating, or otherwise).

Achieving the desired microprotrusion structure can be achieved through any reliable technique. One particularly preferred approach is to form a negative microprotrusion surface structure in a wall of a tool that defines a cavity into which a charge of material is delivered in a molten state. While in contact with the negative microprotrusion surface structure in the tool wall, the charge will solidify at its outer surface and thereby assume the microprotrusion surface structure.

As will be appreciated from the above, the achievement of a microprotrusion surface structure is a function of the quality of the negative microprotrusion surface structure in the tool wall. Different approaches to the formation of such structure in the tool wall may be employed. For example, one approach may employ photolithographic techniques by which an image of the structure is developed on a photoresist material, thereby selectively causing the removal of photoresist material. Thereafter, the exposed underlying surface of the tool wall is etched for achieving the desired structure.

Another approach, which is also involves contacting a workpiece with a tool for defining a surface structure in a tool wall is to mechanically engrave the tool, such as by use of a multi-axis milling machine.

Electrical discharge machining may be employed for making the tool. In such an approach the use of a multi-axis machine may similarly be employed.

Yet another approach, which is particularly attractive for the formation of a texture having sharply defined extremities (e.g., pointed cone tips, or possibly blunted cone tips), is a non-contact material removal technique, such as a laser modified tool wall. By way of example, a laser etching or laser engraving process may be employed for achieving the desired surface structure in the tool. Under such an approach it is possible to program a laser for two-dimensional or three-dimensional surface modification, so that a flat wall, a contoured wall or both may be modified. Heretofore, the practice of this approach has been discouraged because of the limited depths for which lasers could successfully be employed for tooling material removal. It has been recognized, however, that it is now possible to successfully employ lasers for this purpose. By way of example, for engraving a tool made of art disclosed mold and tool steels (e.g., carbon tool steel, alloy tool steel, or stainless tool steel), one or more of a Nd:YAG (Neodymium doped Yttrium Aluminum Garnet), Nd:YLF laser, Nd:YVO4 laser, carbon dioxide laser, or other suitable laser is employed, having a wavelength from about 200 to about 1600 nm, e.g., a UV laser having a wavelength of about 355 nm. Green light lasers may be employed too. One approach may be to employ a laser that is carried by a multi-axis head (e.g., a 2-, 3-, 4-, 5- or even 6-axis CNC operated system). Another approach is to employ a fixed laser, which has its beam re-directed by one or a plurality of motor controlled mirrors (e.g., a galvanometer). The laser is controlled by data obtained, for example, from 3-dimensional CAD/CAM software.

One specific approach employs the use of a collimated beam that is substantially orthogonal to the workpiece tool. A beam may be angularly disposed relative to the orthogonal axis for achieving a desired material removal geometry.

It will be appreciated that the tool whose surface is modified in accordance with the teachings herein need not necessarily be made of conventional tool steel, but may be made from any material suited for the intended application. Without limitation, the tool material may be a metal, a plastic, a ceramic, or any combination thereof. For example, the tool may be an alloy including as its largest component a metal selected from aluminum, copper, tin, zinc, magnesium, nickel, chrome, iron, or any combination thereof. Examples of plastics that may be employed (e.g., as a calendar roll for a post extrusion processing step), include a rubber, fluoropolymer, epoxy, polyurethane, nylon, polycarbonate, polyester, phenolic, or any combination thereof. Examples of suitable ceramic tool materials (e.g., a tool that includes a carbides (e.g., tungsten carbide, titanium carbide, or otherwise) or another suitable material.

One particularly preferred approach to providing the first body herein involves contacting a molten thermoplastic material (e.g., a polyolefin such as polyethylene, polypropylene, or a mixture thereof, and specifically one having a melt index per ASTM D1238 of about 0.05 to about 350 g/10 min., and more specifically about 0.5 to about 80 g/10 min., with a surface of a tool that has walls that have been laser modified for realizing a microprotrusion surface structure in the resulting product. Examples of particularly attractive feedstock or compounded materials (which optionally may be glass-filled, mineral filled or a combination thereof) are available from The Dow Chemical Company under the trade designation DOWLEX®, INSPIRE® (e.g., TF7000, TF 1301, TF 1500, TF 2300, GF080ESU), DOW Polypropylene RESiNS™ (e.g., DOW Polyethylene RESiNS™ (e.g., AFFINITY PF1140, DOWLEX 2038, DOWLEX 2045, LDPE 133A, LDPE 959S).

In one approach, the first body is separated from the tool after at least the microprotrusion surface structure has been solidified, and more preferably after the entire body has cooled so that the heat of the first body will not substantially plastically alter the microprotrusion surface structure from the shape. It is possible, however, to manipulate the steps of separating the first body from the tool for achieving a modified microprotrusion surface structure. For example, for a plastic body, separation may occur above the glass transition temperature of the plastic, thereby allowing microprotrusions to be stretched, twisted, offset, or otherwise displaced.

As discussed, though not necessary in every instance, the second body of the present teachings typically will be a material that is different in composition, form, or both, relative to the material of the first body. For example, it is possible that the second body is a foam, but the first body is a densified solid. It is also possible that the second body may include a fibrous surface structure (e.g., a glass fiber, a carbon fiber, a plastic fiber or otherwise).

One particular approach is to attach a plastic body (e.g., a thermoplastic or a thermoset) as the second body, wherein the plastic body is in a densified solid form, foam form or a combination thereof. The foam forms herein may be open cell foams, closed cell foams, or a combination thereof. One specific attractive combination in accordance with the present invention is to employ as the first body a plastic that includes a polyolefin, and to attach that first body to a plastic foam, and specifically a thermoset plastic foam, such as a polyurethane foam.

A sandwich structure that includes one or more layers of foam (e.g., an art disclosed acoustical foam, structural foam or otherwise) disposed between opposing substrates. For example, without limitation, such a structure may include a skin of a material selected from a thermoplastic polyolefin, a thermoplastic urethane, a thermoset urethane, a polyvinyl-chloride/acrylonitrite-butadiene-styrene or any mixture thereof, beneath which lies a polyurethane foam, a polypropylene foam, a polyolefin foam, or a mixture thereof, which in turn is disposed over a long glass fiber polypropylene layer.

Another possible approach is to substitute a skin of a self skinning foam as one of the above substrates. Additional layers may also be applied, including decorative inserts, a layer of paint or the like, which optionally may be adhesively bonded or welded to a substrate, foam or both.

Another possible combination involves a skin overmolded on a substrate with an interface defined therebetween that includes a fringed microprotrusion structure. The skin may be solid, porous, smooth, textured or any combination. The substrates may be solid or porous, sheets or films. They may be shaped or monolithic. For example, two foam layers may be attached via a microprotrusion interface structure. One or both of the foams may have a film attached to an outer surface.

In the above examples, it is possible that the microprotrusions will be employed. It is also possible that one or more layers described may be omitted, such that the article includes only a substrate having a microprotrusion structure with foam (e.g., a structural foam, an acoustical foam or otherwise) attached to it.

Another possibility would be to omit the foam and attach two substrates together via a microprotrusion structure interface, the microprotrusions being on one or both of the substrates. The substrates can be of similar or dissimilar materials (e.g., each substrate may differ in terms of its respective melting points; or one of the substrates may be applied as a coating, such as a paint, a primer, an adhesive or other form of a tie layer or otherwise with a thickness of the coating as high as 1 mm or larger).

In one specific aspect, a structure is contemplated that provides a debondable joint. For example, an article or layer may be bonded to a substrate that has a microprotrusion structure, with an intermediate adhesive layer. In such an instance it is possible to achieve a substantially adhesive failure as between the article or layer and the substrate that has the microprotrusion structure.

The attaching step may be performed so that an interface is defined between the first body and the second body. Though it is possible that the interface will be free of any added bonding agent (e.g., an adhesive, a primer or both), such omission is not necessary, as the teachings above already have demonstrated. Examples of bonding agent systems suitable for use herein include, without limitation, cyanoacrylates, (meth)acrylics, polysulfones, polyurethanes, silicones, epoxies, or the like. Hot melt adhesives (e.g., thermoplastic adhesives) may be employed. One particularly attractive adhesive includes an organoborane/amine complex, such as disclosed in U.S. Pat. Nos. 6,710,145; 6,713,579; 6,713,578; 6,730,759; 6,949,603; 6,806,330; and Published U.S. Application Nos. 2005-0004332 and 2005-0137370; all of which are hereby expressly incorporated by reference.

The second body may be attached to the first body during or after the formation of either or both of such bodies. In generally, the first body will be formed so as to include the desired microprotrusion structure, and thereafter the second body will be attached to it, such as by employing the first body as an insert within a tool for forming the second body. Thus, it is envisioned that while in a liquid state, in a relatively viscous state, or even in a solid state (subject to an activation step), the ingredients of the second body are contacted with the first body, and the microprotrusion surface structure of the first body is infiltrated with the liquid or viscous material. Upon solidification of the second body, it will be firmly attached to the first body. For example, one approach calls for placing the first body with the microprotrusion surface structure into a tool before or during the curing of a thermoset foam precursor.

Another approach to attachment involves the application of a suitable weld energy for welding the first body to the second body (e.g., radiofrequency weld, vibration weld, ultrasonic weld or otherwise).

In a particular preferred aspect, the attachment is such that separation of the second body from the first will involve a cohesive failure of the second body. However, within the scope of the present invention, cohesive failure is not always a requirement.

It is possible that desirable results for many intended applications may be realized where the second body and the first body are attached by an adhesive bond at the interface having a lap shear strength as measured per SAE J1525 of at least about 5 psi, and more specifically at least 125 psi, and still more specifically at least 250 (e.g., about 500 psi or higher or even about 1000 psi or higher). A typical bond strength for many applications will be about 5 to about 500 psi. As well, it is possible to obtain a peel strength per ASTM D3165-91 of greater than about 250 psi (e.g., about 400 psi or higher). For example, with a microprotrusion diameter of about 100 microns and a height of about 200 microns yields a peel strength of about 300 psi.

Yet another possible embodiment involves the attachment of bodies that use the teachings herein, where the microprotrusions are contacted with a tape, fabric or other form of material that includes a coextrusion of a first material having a melting point that is higher than a second material. In such an embodiment, it is possible to heat the coextrudate to a temperature between the respective melting points of its layers, and contact the outer layer with the microprotrusion surface structure of the first body, while preserving the higher temperature melting point layer in a solid state. More specific details about such coextruded structures can be found, for example in PCT Application Nos. US05/38105, (1062-041WO1)); US05/37729 (1062-041WO2); US05/38103 (1062-041WO3); US05/38104 (1062-041WO4); and US05/38091 (1062-051WO) all filed on Oct. 20, 2005, all of which are incorporated by reference.

As can be appreciated from the above, the present invention finds utility in a variety of applications. Resulting articles are also within the scope of the invention. By way of example, it is possible to make a vehicle instrument panel that includes a polyurethane foam that is attached to a polypropylene body having a microprotrusion surface structure with or without an intermediate surface treatment. Other applications include fuel cell assembly attachment, air filtration assemblies, metal plated plastic substrates, bond enhancement substrates, attachment of carpet or textiles to a substrate, noise-vibration-harshness dampers, buzz-squeak-rattle dampers, sound attenuation, sound deadening, vehicle headliner assemblies, vehicle interior trim panels, furniture, handles, arm rests, steering wheels, vehicle bumper assemblies, decorative appliques, laminated construction panels, subflooring, insulation panels, underlayers for coated (e.g., paints such as a reflective paint, stucco, mortar, cement, etc.) wall surfaces, oriented strand boards, structural insulated sheeting, composite deck boards, as a constrained layer within a sandwich (e.g., bi-metal) laminate, gaskets and seals, grips for hand or power tools (e.g., grips presenting a soft-touch surface). As can be appreciated, it may be possible to eliminate or reduce the usage of mechanical fasteners for many assembly steps for products herein.

It is also seen how the teaching herein can be readily employed in applications requiring adhesive green strength enhancement (e.g., via surface area enhancement), or in which there is a need to release fluid (e.g., gas or liquid) buildup in the course of manufacturing an article, such as a laminate article. The teachings herein thus further contemplate processes that include one or both steps of enhancing adhesive green strength using microprotrusions, or releasing buildup by dispersing gas through the microprotrusion structure.

Particularly when the article is an instrument panel, the methods and articles further contemplate the optional manufacture of an integrated airbag door. Any such instrument panel may be part of an assembly (e.g., a cockpit module) that may further include one or any combination of a wiring harness, an audio system component, a climate control component, a steering wheel component, an instrument gauge, an electronic read-out device, or a console.

Examples of particular instrument panel structures that may be incorporated as part of the instrument panels according to the present teachings include, without limitation, those described in U.S. Pat. No. 6,739,673, and published U.S. Application Nos. 2004/0160089, 2004/0188885, all incorporated by reference.

Articles may be produced in accordance with the teachings of the present invention so that they exhibit one or a combination of features such as mold in color, low gloss, high gloss, grain or texture, multi-tone appearance, soft-touch feel over all or a selected portion of the surface.

Plastics that are employed herein may be subjected to one or more secondary operations for improving their properties. By way of example, without limitation, they may be coated or otherwise surface treated. For example, in one embodiment, the surfaces of a body can optionally undergo a preliminary treatment prior to attachment to another body. This optional treatment can include cleaning and degreasing, plasma coating, corona discharge treating, coating with another surface treatment, coated with a bonding agent, or any combination thereof. In one embodiment, a body may be subject to a carbon-silica based plasma deposited coating, e.g., as described in U.S. Pat. No. 5,298,587; U.S. Pat. No. 5,320,875; U.S. Pat. No. 5,433,786 and U.S. Pat. No. 5,494,712, all hereby incorporated herein by reference. Other surface treatments might also be employed such as plasma surface treatment pursuant to art disclosed teachings as found in U.S. Pat. No. 5,837,958, incorporated herein by reference. It is also possible that during the manufacture of articles herein, one or more agents may be employed within the tool for imparting a change in surface characteristic of the resulting formed material. For example, an organic compound may be introduced into the tool ahead of or simultaneously with molten material. The organic material will impart a functionality to the surface of the resulting article (such as by the result of a reaction of trapped gas that oxidize the compound).

It is seen that among the many advantages of the present teachings is the possibility if desired to reduce or eliminate the need for secondary operations that would involve volatile organic components or that pose some other handling or disposal issue. The teachings advantageously may also avoid the need for secondary operations that employ high amounts of energy consumption.

Microprotrusions herein may be disposed on either or all of the first second or other body (e.g., on the skin, an underlying substrate or both).

It should also be appreciated that either or both of the first body or the second body herein may form a skin of an article, a supporting or other functional structure concealed at least partially within the article, a decorative component that is visible in service or otherwise.

It will be appreciated that dissimilar materials that are bonded according to the present teachings may include materials from within the same class of plastics, but which vary by one or more characteristics, such as melting point, crystallinity, orientation or otherwise.

Reference herein to “first” and “second” are not intended as limiting to combinations that consist of only first and second items. Where so-referenced, it is possible that the subject matter of the present invention may suitably incorporate third, fourth or more items. Except where stated, the use of processing steps such as “solidifying” or its conjugates do not require completion of the entire recited step; a partial performance of the step is also contemplated. Moreover, the disclosure of “a” or “one” element or step is not intended to foreclose additional elements or steps.

Unless stated otherwise, dimensions and geometries of the various embodiments depicted herein are not intended to be restrictive of the invention, and other dimensions or geometries are possible. Plural structural components or steps can be provided by a single integrated structure or step. Alternatively, a single integrated structure step might be divided into separate plural components or steps. However, it is also possible that the functions are integrated into a single component or step.

In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute processes in accordance with the present invention.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method for making a composite article, comprising the steps of:
a. providing a first body that includes a fringed microprotrusion surface structure; and
b. attaching to the first body, a second body for defining an interface that includes at least a portion of the fringed microprotrusion surface structure.

2. The method of claim 1, wherein the fringed surface structure is characterized by a plurality of generally conical microprotrusions that project from a surface of the first body.

3. The method of claim 2, wherein the generally conical microprotrusions are generally closed at their distal ends.

4. The method of claim 2, wherein the generally conical microprotrusions include a curved distal end for defining a hook.

5. The method of claim 2, wherein the generally conical microprotrusions generally have an aspect ratio (height to diameter) in the range of about 0.5:1 to 7:1.

6. The method of claim 5, wherein the generally conical microprotrusions generally have an aspect ratio (height to diameter) in the range of about 2:1.

7. The method of claim 2, wherein over at least 20% by area of the fringed surface portion of the first body, the generally conical microprotrusions are present in a concentration of at least about 225 protrusions per cm².

8. The method of claim 2, wherein the generally conical microprotrusions have an average diameter of from about 40 to about 350 microns.

9. The method of claim 2, wherein the generally conical microprotrusions have an average height of about 25 to 500 microns.

10. The method of claim 2, wherein the first body is plastic and the polymer of the first plastic body includes at least 40 wt % of a polyolefin polymer.

11. The method of claim 7, wherein the first body is plastic and the polymer of the first plastic body includes at least 60 wt % of a polypropylene.

12. The method of claim 11, wherein the first body is plastic and the polymer of the first plastic body consists essentially of a polypropylene.

13. The method of claim 2, wherein the first body includes glass fiber reinforcement.

14. The method of claim 13, wherein the first body includes long glass fiber reinforcement.

15. The method of claim 2, wherein the first body is plastic and the first plastic body has a melt index per ASTM D1238 of at least about 20.

16. The method of claim 2, wherein the second body is plastic and includes at least 40 wt % of a polyurethane foam, and further wherein the attaching step occurs when the polyurethane is foamed.

17. The method of claim 1, wherein the step of providing a first body includes injecting molding or die casting the first body.

18. The method of claim 1, wherein cohesive failure of the second body is observed upon separating the first body from the second body.

19. The method of claim 1, wherein the resulting lap shear, or peel strength observed upon separating the first body from the second body is at least three times greater than that which would be observed if compared with a lap shear, or peel strength of a joint formed by a comparable structure that omits the fringed surface structure from the first body, substituting in its place a surface that has only been mechanically roughened to increase surface area by 40%.

20. The method of claim 1, wherein the composite article is an instrument panel that is substantially free of an adhesion promoter between the first body and the second body.
